(19) United States
(12) Patent Application Publication
(10) Pub. No.: US 2009/0238158 A1
(43) Pub. Date: Sep. 24, 2009

(54) Packet Fragment Adaptation for Improved Coexistence

(75) Inventor: Michael Lewis, London (GB)

Correspondence Address: LEE & HAYES, PLLC, 601 W RIVERSIDE AVENUE, SUITE 1400, SPOKANE, WA, 99201, US

(73) Assignee: INFINEON TECHNOLOGIES AG, Neubiberg (DE)

(21) Appl. No.: 12/052,722

(22) Filed: Mar. 20, 2008

(51) Int. Cl. H04Q 7/24; H04B 7/00

(52) U.S. Cl. 370/338; 455/41.2

(57) ABSTRACT

This disclosure relates to transmitting wireless packets between multiple stations and changing the duration or fragmentation of the packets.

### BACKGROUND

This application relates to transmission of wireless packets and, more particularly, to changing the packet size or fragmentation of packets when simultaneously transmitting wireless packets from different sources.

IEEE section 802.11 wireless local area network (WLAN) signals and Bluetooth signals (as defined in specification 2.1 provided by the Bluetooth SIG of Bellevue, Wash., USA) both operate in the 2.4 GHz frequency band, and therefore suffer problems with coexistence. The problem is exacerbated in portable devices such as mobile telephones, since it is necessary to locate the Bluetooth and WLAN transmission devices physically very close to one another and possibly to share the same antenna.

For example, FIG. 1 shows a system 100 including a first station 102 (also referred to herein as a local station) having a WLAN transceiver 104 coupled with a Bluetooth transceiver 106. The WLAN transceiver 104 transmits and receives WLAN packets from a second station 108 (also referred to herein as a remote station) via a WLAN link 112. The Bluetooth transceiver 106 transmits and receives Bluetooth packets from a third station 110 via a Bluetooth link 114. Thus when a Bluetooth signal is being transmitted, the WLAN receiver 104 cannot receive WLAN signals as its receive path is overloaded. Also when WLAN are being transmitted, a Bluetooth receiver 106 cannot receive Bluetooth signals as its receive path is also overloaded. Further in a single antenna system, only one of the two systems (e.g. either a WLAN transmitter 104 or a Bluetooth transmitter 110) may be able to transmit or receive at the same time.

These problems have led to a number of standardized or semi-standardized solutions to reduce the probability of loss of important data in the above systems. A widely deployed mechanism is called packet traffic arbitration, where a judgment is made about relative priority of a packet in the case that a conflict occurs, with the lower priority packet transmissions being aborted.

This mechanism leads to a number of problems in practical situations. Bluetooth signals have a regular, time-scheduled activity pattern. For example, in the case of Bluetooth signals containing audio data that is routed to and from a headset, a burst of data (also referred to as a Bluetooth packet stream) is transmitted and received in a fixed repetition pattern within a period of milliseconds, with no transmission activity occurring in between the bursts. There is little or no time to retransmit this audio data without causing disturbance to the audio. Consequently the Bluetooth signals containing audio must be treated with higher priority than WLAN signals, which can be freely retransmitted. Treating the Bluetooth signals with higher priority slows down the effective transmission rate of the WLAN signals, resulting in retransmission of the WLAN signals and reducing the overall WLAN throughput. In the event that the WLAN transmissions are longer in duration than the interval between Bluetooth operations, the case may even occur that an entire packet can never be transferred without being interrupted by the Bluetooth operation. At the local WLAN device, it is possible to make use of knowledge about the Bluetooth activity pattern and thereby choose to transmit shorter packets, since the WLAN standard allows for the fragmentation of a longer packet into a number of shorter fragments. However, the remote WLAN device operates independently of the local Bluetooth device operation and cannot adapt its packet lengths. Therefore there is a risk that long packets from the remote device may never successfully be received.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items.

FIG. 1 is system diagram of a wireless system for transmitting WLAN and Bluetooth protocols to different stations.

FIG. 2 is timing diagram of packets being transmitted between a local and a remote stations.

FIG. 3 is block diagram of a local or remote station for transmitting wireless protocols.

FIG. 4 is a flow diagram of a process for transmitting packets by a local station.

FIG. 5 is a flow diagram of a process for transmitting and receiving packets by a remote station.

### DETAILED DESCRIPTION

Disclosed herein are techniques for transmitting packets between a local station and a remote station to optimize performance in the case that one or both of the stations contain a Bluetooth transceiver. In a disclosed implementation the local station includes a Bluetooth transceiver to transmit Bluetooth packets at periodic intervals. The local station also includes a WLAN transceiver to transmit WLAN packets to and receive WLAN packets from the remote station. These packets may be transmitted in their entirety, or may be fragmented into a number of smaller packets. The WLAN transceiver, during the transmission of the Bluetooth packets, transmits to the remote station fragmented WLAN packets at predetermined time intervals, each of the plurality of fragmented WLAN packets is transmitted after completion of transmission of each of the plurality of Bluetooth packets and the fragment length is chosen so that there is adequate to transmit at least one packet and receive any required response frames between the Bluetooth packets. The remote station includes a transceiver to respond to the transmission of fragmented WLAN packets by transmitting fragmented packets to the local station.

In one described implementation a system is shown that includes a wireless remote station that sends and receives: 1) wireless local area network (WLAN) packets from a remote station, and 2) Bluetooth packets from a secondary station. The system includes a device that comprises a first transceiver to transmit and receive fragmented and un-fragmented WLAN packets and a second transceiver to transmit and receive Bluetooth wireless packets. The device has a memory to store WLAN data and Bluetooth wireless data. Also included with the device is a control module to provide an indication to the first transceiver to transmit the WLAN data as fragmented WLAN packets. The control module further provides an indication to the second transceiver to transmit the Bluetooth wireless data as wireless Bluetooth packets. The control module provides an indication to the first transceiver to transmit the WLAN data as un-fragmented WLAN packets upon completion of transmission of the Bluetooth data.

According to another implementation, a method is provided for observing by one station a maximum fragment duration of wireless packets transmitted by another station and changing the fragment duration of transmission of the wireless packets by the observing station to a maximum fragment duration not substantially longer than that the fragment duration used by the other station.

The techniques described herein may be implemented in a number of ways. One example environment and context is provided below with reference to the included figures and ongoing discussion.

Exemplary Systems and Operation

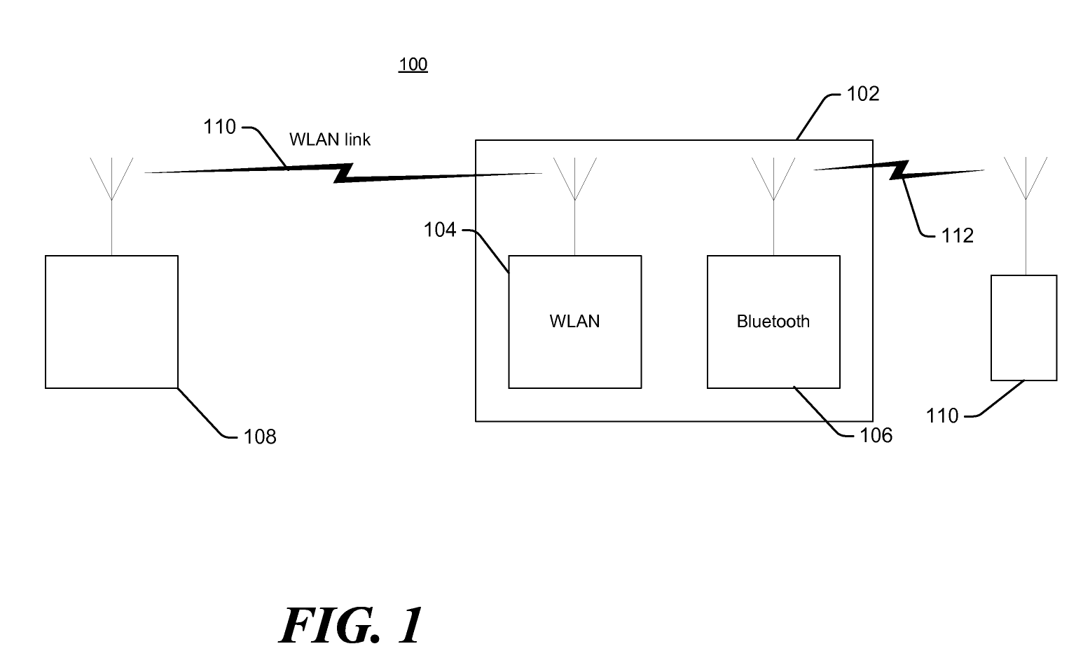

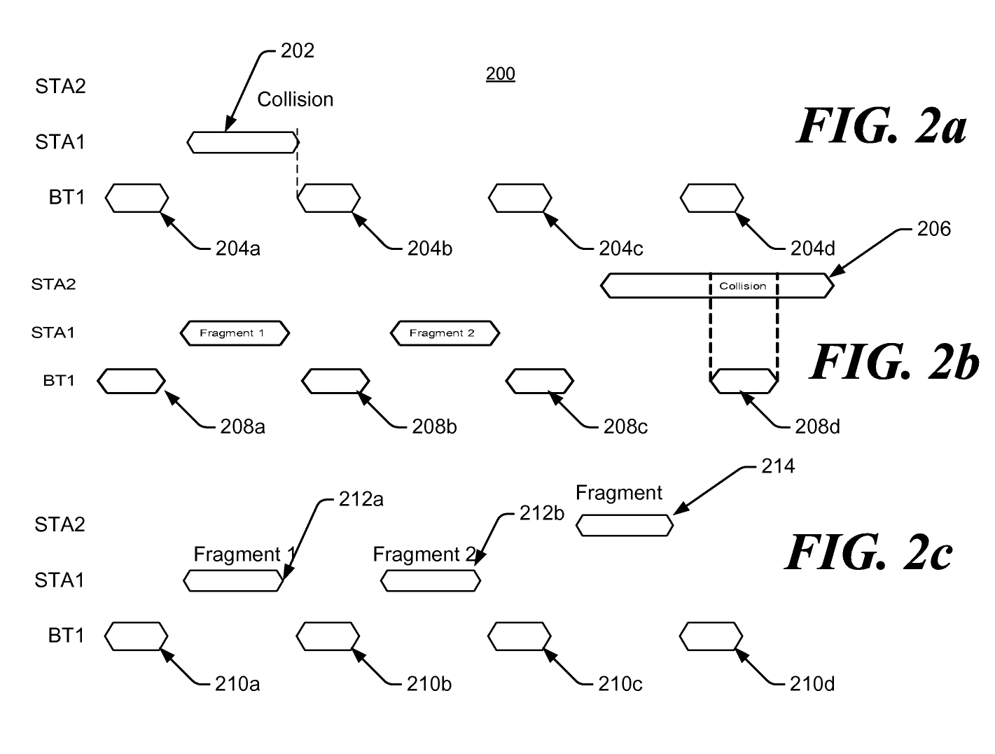

FIGS. 2a-2b illustrates a timing diagram 200 of packets being transferred using the system 100 shown in FIG. 1. In FIGS. 2a-2b, no mechanisms are active to prevent collisions between WLAN signals and the Bluetooth signals. In FIG. 2a, WLAN transceiver 104 in the first station 102 transmits a packet 202 at the same time that the co-located Bluetooth transceiver 110 transmits packets 204a-204d. In this case, packet 202 collides with packet 204b and the WLAN transmission is aborted.

In FIG. 2b, the second station 108 transmits a WLAN packet 206 and the WLAN transceiver 104 in first station 102 receives the packet. At the time of the WLAN 206 transmissions, the co-located Bluetooth transceiver 110 transmits packets 208a-208d. In this case the reception of WLAN packet 206 may be aborted or interfered with by the Bluetooth packet 208d.

WLAN standards provides for the possibility for a station to fragment its packet transmissions into a number of shorter packets, which are subsequently reassembled at the receiver. In the case of a device with co-located Bluetooth transceiver 106 and WLAN transceiver 104 (FIG. 1), the local WLAN transmissions can be fragmented such that WLAN packets 210a and 210b can, with high probability, be sent between transmissions of packets 208a-208d of the Bluetooth transceiver 106, as depicted in FIG. 2b.

However, the second station 108 has no knowledge of the Bluetooth transceiver 106 or its operating characteristics (and there is no standardized method of providing such information from the first station to the second station 106). Therefore, the second station 108 will not know that it should fragment the transmission of its packets, and its packets will still collide with the Bluetooth packets, even if mechanisms are used at the first station 102 (Also referred to as STA 1) to synchronize the operation of the second station 108 with the Bluetooth transmissions by the first station 102 (such as transmitting a CTS-to-self message to prevent the second station 108 (Also referred to as STA 2) from starting a transmission during a Bluetooth transceiver transmission). As shown in FIG. 2B, the length of the packets transmitted by the second station 108, such as packet 206, may be such that it will always collide with Bluetooth transmissions, such as packet 208d. Consequently, the transmission of WLAN packets by the second station 108 will fail after a certain number of attempts.

To avoid these failures, the second station 108 is configured to observe the maximum duration of the WLAN packets transmitted by the first station 102, and fragments its own packets and sets their duration such that the packets that the second station 108 sends are not substantially longer in duration than those it has received. In the case of WLAN packets, in one implementation only non-final fragmented packets can be used for this observation, since the final fragmented packet may be shorter.

The first station 102 is also configured to adapt the duration of its WLAN packets based on knowledge of the local conditions around the first station (e.g. the operation of the co-located Bluetooth transceiver 106). The second station 108 may also shorten the duration of its transmitted fragmented WLAN packets independently of the first station 102 due to a local interferer (e.g. a Bluetooth transceiver collocated with the second station 108).

For example, shown in FIG. 2c are packets 210a-210d transmitted by Bluetooth transceiver 106. An indication of the Bluetooth transmission by a collocated Bluetooth transceiver 106 is provided to WLAN transceiver 104, which responds by transmitting fragmented packets 212a and 212b between the Bluetooth transmissions. The second station 108 observes the fragmented packets sent by the first station 102 and responds by fragmenting the packets that it transmits itself, such as WLAN packet 214, having a duration not substantially longer than the duration of WLAN packets 212a and 212b so as not to interfere with the Bluetooth transmission.

In the event that the shortening of the duration of packets is applied at more than one station simultaneously, the maximum fragment duration chosen in response to observing a particular fragment duration from the peer station should be substantially equal to the duration used by the peer station: otherwise, the peer station will observe the shorter duration, and in turn shorten its own fragment duration, leading to selection of continually shorter and shorter fragment durations. This rule does not, however, affect the local decision to adapt the local fragment duration to local disturbers (e.g. a Bluetooth transceiver) since an adaptation at the peer station is desired in this case.

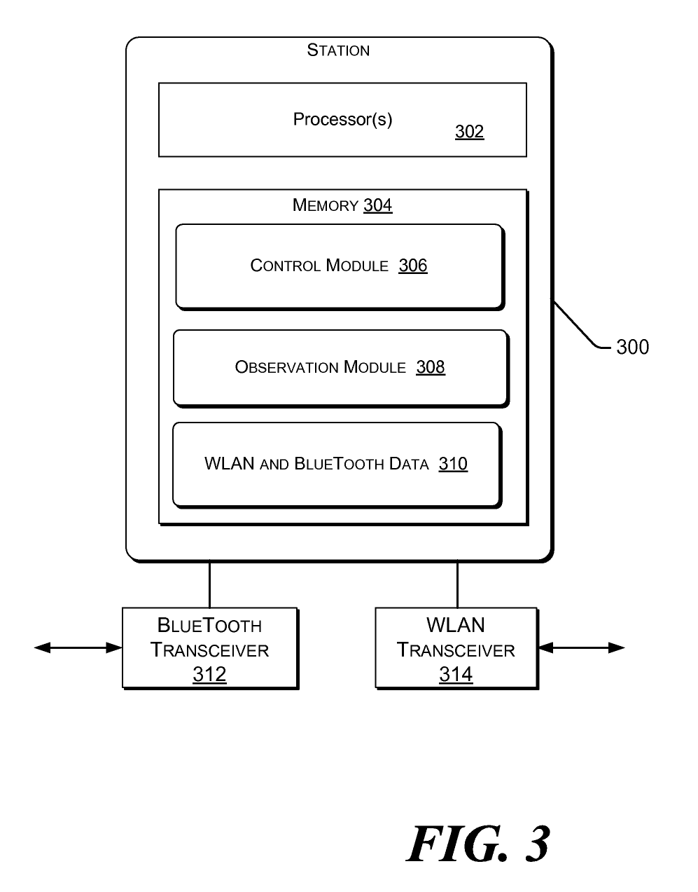

FIG. 3 shows a block diagram illustrating selected modules in one of a client device or one of the stations, such as first station 102, second station 108 or station 110 (FIG. 1) of system 100.

Station 300 may be any computing device capable of communicating with a network, and is also referred to herein as a client device. In one embodiment, the station 300 is a general purpose desktop computing device that is connected to a wireless network. Although the illustrated station 300 is depicted as a mobile communication device, station 300 may be implemented as any of a variety of conventional computing devices including, for example, a server, a notebook or portable computer, a workstation, a mainframe computer, desktop PC, a PDA, an entertainment device, a set-top box, an Internet appliance, a game console, and so forth.

The station 300 has processing capabilities and memory suitable to store and execute computer-executable instructions. In this example, station 300 includes one or more processors 302, memory 304 and is coupled with other devices via Bluetooth transceiver 312 (also referred to as a Bluetooth transceiver circuit) or WLAN transceiver 314(also referred to as a WLAN transceiver circuit). When station 300 operates as remote station, such as station 106, the Bluetooth transceiver 312 may or may not be included.

The memory 304 may include volatile and nonvolatile memory, removable and non-removable media implemented in any method or technology for storage of information, such as computer-readable instructions, data structures, program modules or other data. Such memory includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, RAID storage systems, or any other medium which can be used to store the desired information and which can be accessed by a computer system.

Stored in memory 304 are control module 306, observation module 308, and WLAN and Bluetooth data 310. The modules may be implemented as hardware, software or computer-executable instructions that are executed by the one or more processors 302. Although a processor 302 is shown executing instructions in memory 304, control module 306 and observation module 308 may be constructed in hardware using an electronic circuit. Alternately, control module 306 and observation module 308 may be provided as hardware circuits that are incorporated within transceivers 312 and 314.

The observation module 308 receives Bluetooth and WLAN packets from Bluetooth transceiver 312 and WLAN transceiver 314. When station 300 is operating as a remote station 108, observation module 308 detects the maximum fragment duration of WLAN packets transmitted by the local station 102. Also, when station 300 is operating as a remote station 108, the observation module 308 observes increases in the maximum fragment duration of WLAN packets transmitted by the local station 102. These detected observations are then provided to control module 306.

The control module 306 and observation module 308 enables the station 300 to receive, process, and exchange data 310 via Bluetooth transceiver 312 and WLAN transceiver 314 with other stations, such as remote station 108 and 110. The control module 306 provides an indication to the WLAN transceiver 312 to transmit the WLAN data 310 as fragmented WLAN packets. Control module 306 also provides an indication to the Bluetooth transceiver 312 to transmit the Bluetooth data as Bluetooth packets. Further, control module 306 provides an indication to the WLAN transceiver to transmit the WLAN data as un-fragmented WLAN packets upon the Bluetooth transceiver 312 completely transmitting the Bluetooth data. When station 300 is operating as a remote station 108, the control module 306 provides an indication to WLAN transceiver 314 to change the duration of the transmitted WLAN packets to ensure that the duration is not substantially longer than or less than the observed maximum duration of the WLAN packets transmitted by the local station 102.

Transceivers 312 and 314 are managed by control module 306. Transceiver 312 periodically transmits Bluetooth signals, and WLAN transceiver 314 periodically transmits WLAN packets. When station 300 operates as a local station 102, the WLAN transceiver 314 transmits de-fragmented WLAN packets to and receives de-fragmented WLAN packets from the remote station 106. The WLAN transceiver 314, after transmission of each of the Bluetooth packets, transmits to the remote station 108 a plurality of fragmented WLAN packets at predetermined time intervals and for a predetermined time duration. The fragmented WLAN packets are transmitted after completion of transmission of each of the Bluetooth packets.

In one implementation when station 300 is a remote station, e.g. station 108, WLAN transceiver 314 responds to the transmission of fragmented WLAN packets using control module 306. Control module 306 prompts transceiver 314 to transmit fragmented WLAN packets to the local station 102. Also the control module 306 responds to any indication (by observation module 308) of observed increases in received WLAN packets. Control module 306 responds to the indication by increasing the maximum fragment duration of the WLAN packets transmitted by transceiver 314 in the remote station 108. As part of the response, control module 306 changes the fragmentation of the WLAN packets transmitted by the remote station to de-fragmented packets. An indication of the fragmentation of the WLAN packets may be specified in a header of the WLAN packet.

Although three stations are shown as receiving Bluetooth and/or WLAN signals, this implementation is meant to serve only as non-limiting examples and may include many more or less stations. The techniques discussed herein are applicable to other types of wireless or wireline transmission systems and protocols.

### Exemplary Process

Exemplary methods are described below that implement an adaptation algorithm to reduce collisions. However, it should be understood that certain acts need not be performed in the order described, and may be modified, and/or may be omitted entirely, depending on the circumstances. Moreover, the acts described may be implemented by a computer, processor or other computing device based on instructions stored on one or more computer-readable media. The computer-readable media can be any available media that can be accessed by a computing device to implement the instructions stored thereon.

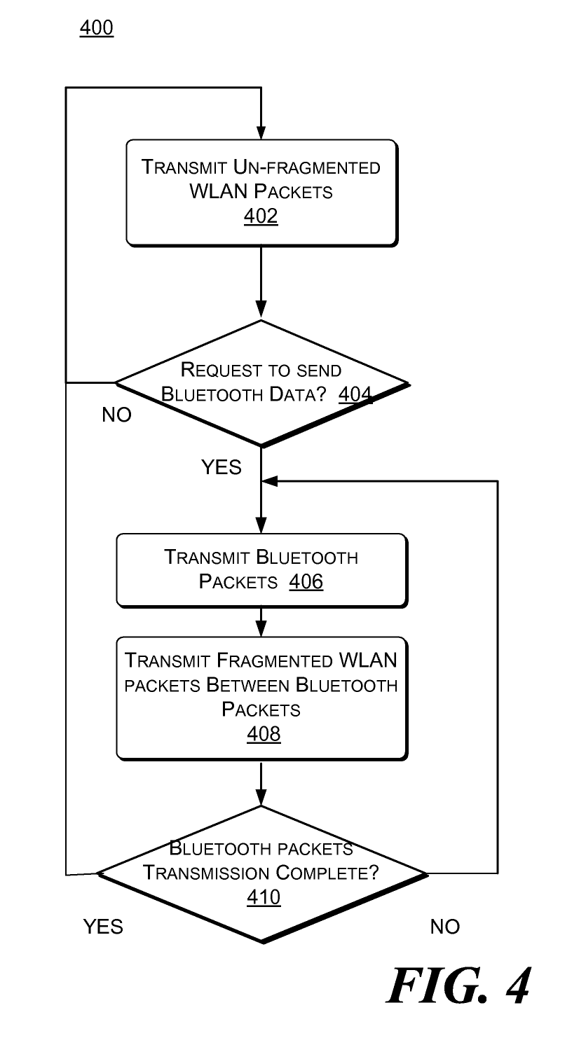

FIG. 4 shows one example implementation of an adaptation process 400 for transmitting WLAN and Bluetooth signals. Such signals may include transmission of WLAN packets from a first station to a second station, such as from local station 102 to remote station 108, and may include transmission of Bluetooth packets from the first station to a third station, such as from local station 102 to remote station 110. The system 100 in FIG. 1 and the station 300 in FIG. 3 may be used for reference in describing one aspect of transmitting Bluetooth and WLAN data 310.

In block 402, un-fragmented WLAN packets are transmitted, such as by station 102 to remote station 108. Transmission is initiated by control module 306 signaling WLAN transceiver 314 to transmit data 310 from memory 304. Transceiver 314 then retrieves data 310 and transmits un-fragmented WLAN packets.

In block 404, control module 306 determines if there is a request to transmit Bluetooth packets. This request may originate from a user of station 300 selecting to use Bluetooth services. If there is not a request to transmit Bluetooth data (“yes“ to block 404), control module continues to transmit un-fragmented WLAN packets in block 402. If there is a request to transmit Bluetooth data, Bluetooth packets are transmitted by station 102 to remote station 110. Transmission is initiated by control module 306 signaling Bluetooth transceiver 324 to transmit Bluetooth data 310 from memory 304. Transceiver 312 then retrieves Bluetooth data 310 and transmits Bluetooth packets in block 406.

In block 408, control module 306 sends a request to WLAN transceiver 314 to transmit fragmented WLAN packets between Bluetooth packets. WLAN data 310 may be retrieved from memory 304 and converted into packets. The packets may then be fragmented and transmitted by WLAN transceiver 314. Each of the fragmented WLAN packets may be transmitted after each of the Bluetooth packets is transmitted. The duration of these WLAN packets would be set to a duration short enough to not collide with the Bluetooth packets (See FIG. 2C).

In block 410, control module 306 determines if all the Bluetooth packets have been transmitted. Such determination may be made by control module 306 receiving an indication from Bluetooth transceiver 314. If all the Bluetooth packets have not been completely transmitted (“No“ to block 410), the process continues at block 406 where the Bluetooth packets are continued to be transmitted. If all the Bluetooth packets have been transmitted, the process continues in block 402 where the WLAN packets are transmitted as un-fragmented packets.

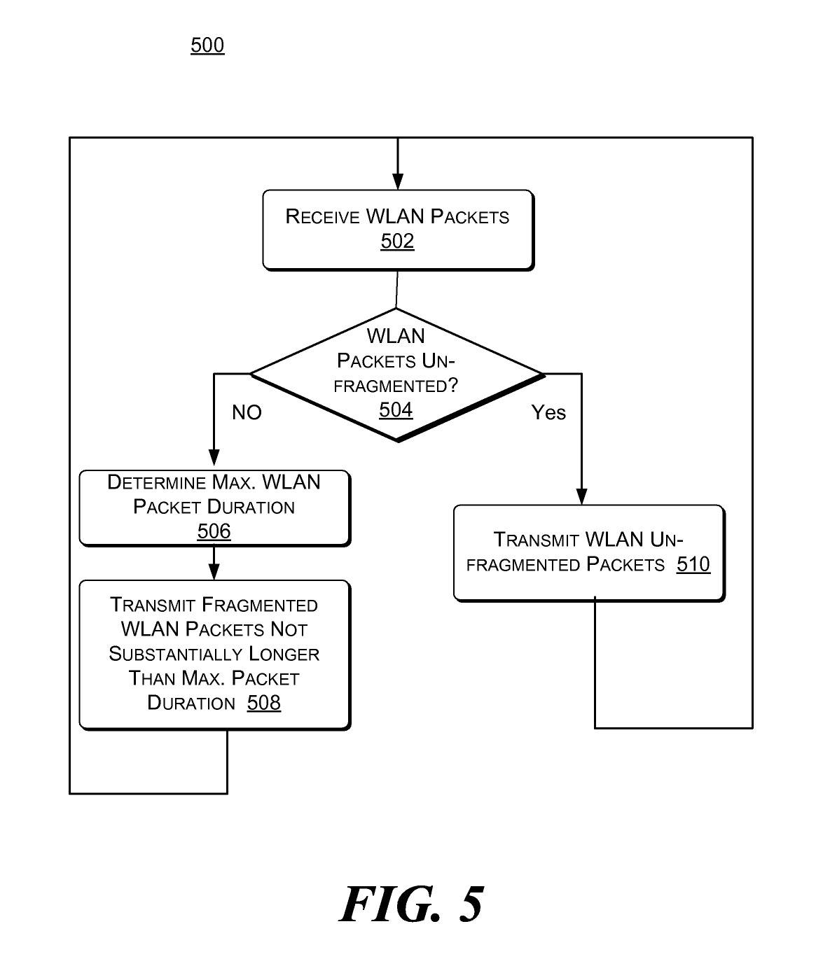

FIG. 5 shows one example implementation of an adaptation process 500 for receiving and transmitting WLAN packets between a second station to a first station, such as between remote station 108 and local station 102. Adaptation process 500 may also be used for the local station 102 to receive WLAN data from the remote station 108. The system in FIG. 1 and the station 300 in FIG. 3 may be used for reference in describing one aspect of transmitting WLAN data.

In block 502, WLAN packets are received by the WLAN transceiver 314 in remote station 108. The transceiver 314 moves the data contained in the packets into memory 304 and provides an indication to the control module 306 that WLAN data is received. The control module in block 504 reads the received WLAN data in memory 304 to determine if the packets are fragmented or un-fragmented. If the WLAN packets are not fragmented (“No“ to block 504), the control module 306 provides an indication to WLAN transceiver 314 to transmit WLAN un-fragmented packets to the local station 102 in block 510. The WLAN transceiver 314 than transmits WLAN data 310 from memory 304 as un-fragmented packets to the local station 102. The process then continues to block 502, where additional WLAN packets are received by the WLAN transceiver 314.

If the WLAN packets are fragmented (“Yes“ to block 504), the observation module 312 then determines the maximum fragmented WLAN packet duration in block 506. The maximum WLAN duration is then fed to the WLAN transceiver 314. The WLAN transceiver 314 than transmits WLAN data 310 from memory 304 as fragmented packets to the local station 102 in block 508. The WLAN packets are set to a duration not substantially longer than the maximum WLAN packet duration detected in block 506. The process then continues to block 502, where additional WLAN packets are received by the WLAN transceiver 314.

In block 508, control module 306 may signal the WLAN transceiver 314 to increase the duration of the fragmented WLAN packets in the event that the duration of the received WLAN packets increase, even if both the local and the remote station implement the adaptation process. A suitable mechanism would be to from time to time (for example, immediately after an improvement in the local conditions, or periodically afterwards) attempt to transmit a fragmented packet with a longer duration. If the remote station also increases its fragmented packet duration, then it may be assumed that the local conditions around the stations support the longer maximum fragment duration. A further indication that the longer fragmented packet duration can or cannot be used is if successful packet receipt is indicated or not by the stations, e.g. by using a standard WLAN acknowledge mechanisms.

### Conclusion

Although the subject matter has been described in language specific to structural features and/or methodological acts, it is to be understood that the subject matter defined in the appended claims is not necessarily limited to the specific features or acts described. Rather, the specific features and acts are disclosed as preferred forms of implementing the claims.

1. A system comprising:
a local station and a remote station, said local station including:
a Bluetooth transceiver circuit to transmit a plurality of Bluetooth packets at frequent intervals,
a WLAN transceiver circuit to transmit un-fragmented WLAN packets to, and receive un-fragmented WLAN packets from, the remote station, said WLAN transceiver circuit, during the transmission of the Bluetooth packets, to transmit to the remote station a plurality of fragmented WLAN packets at time intervals to avoid collisions with the Bluetooth packets, each of the plurality of fragmented WLAN packets being transmitted after completion of transmission of some of the plurality of Bluetooth packets; and
said remote station including a transceiver circuit to respond to the transmission of fragmented WLAN packets by transmitting a plurality of fragmented packets to the local station, the remote station comprising an observation module to detect a maximum fragment duration of WLAN packets transmitted by the local station and to decrease the maximum fragment duration of the WLAN packets transmitted by the remote station to a duration not substantially greater than the observed maximum fragment duration of the WLAN packets transmitted by the local station.

2. A system as recited in claim 1, wherein said observation module is operable to observe an increase in the maximum fragment duration of WLAN packets transmitted by the local station.

3. A system as recited in claim 2, wherein said remote station comprises a control module to respond to the observed increase by increasing the maximum fragment duration of the WLAN packets transmitted by the remote station and to change the WLAN packets transmitted by the remote station to de-fragmented packets.

4. In a system, a wireless remote station that transmits and receives wireless local area network (WLAN) packets from a remote station and other wireless packets to a secondary station, a device comprising:
a first transceiver to transmit fragmented and un-fragmented WLAN packets;
a second transceiver to transmit other wireless packets;
a memory including WLAN data and wireless data for transmission;
an observation module to monitor WLAN packets transmitted by the remote station and to detect a maximum fragment duration of WLAN packets transmitted by the remote station; and
a control module to provide an indication to the first transceiver to transmit the WLAN data as fragmented WLAN packets and to provide an indication to the second transceiver to transmit the wireless data as wireless packets, said control module to provide an indication to the first transceiver to transmit the WLAN data as un-fragmented WLAN packets upon completion of transmission of the wireless data, said control module to monitor, said control module to decrease the maximum fragment duration of the WLAN packets transmitted by the wireless station to a duration not substantially greater than the observed maximum fragment duration of the WLAN packets transmitted by the remote station.

5. A system as recited in claim 4, wherein the wireless packets are Bluetooth packets.

6. A system as recited in claim 4, wherein the WLAN transceiver transmits a fragmented WLAN packet after the end of a wireless packet transmitted by the wireless transceiver.

7. In a system with a wireless remote station that transmits and receives wireless local area network (WLAN) packets from a local station, a device comprising:
an observation module to determine the maximum duration of the WLAN packets transmitted by the local station; and
a control module to adapt the transmission of WLAN packets to ensure that the length of WLAN packets are not substantially longer than the maximum duration of the WLAN packets transmitted by the local station.

8. A device as recited in claim 7, wherein said observation module is operable to determine if the wireless packets transmitted by the local station are fragmented.

9. A device as recited in claim 8, wherein said observation module is operable to observe an increase in the maximum fragment duration of wireless packets transmitted by the local station station; and wherein said control module, in response to the observed increase, is operable to increase a fragment duration of the transmitted wireless packets.

10. A device as recited in claim 9, wherein said observation module is operable to detect de-fragmented packets from the location station, and wherein said control module is operable to change a fragmentation of wireless packets transmitted to de-fragmented packets in response to detecting de-fragmented packets.

11. A device as recited in claim 10, wherein said observation module is operable to determine if the WLAN packets are fragmented by examining a header of at least one of the WLAN packets.

12. A method comprising:
transmitting de-fragmented WLAN packets between a local station and a remote station;
transmitting a plurality of Bluetooth packets at periodic intervals;
during the transmission of the Bluetooth packets, transmitting to the remote station a plurality of fragmented WLAN packets at intervals, each of the plurality of fragmented WLAN packets being transmitted after completion of transmission of one of the plurality of Bluetooth packets; and
responding by the remote station to the transmission of fragmented WLAN packets by transmitting a plurality of fragmented packets to the local station.

13. A method as recited in claim 12, wherein transmission of the fragmented WLAN packets is determined by the remote station examining the header of the packet.

14. A method as recited in claim 12, further comprising, transmitting to the remote station a plurality of un-fragmented WLAN packets after completion of transmission of Bluetooth packets.

15. A method as recited in claim 12, wherein monitoring the transmission of WLAN packets from the local station to determine when the WLAN packets are un-fragmented, and responding by the remote station to the local station transmitting un-fragmented WLAN packets by transmitting un-fragmented WLAN packets to the local station.

16. A method as recited in claim 12, further comprising:
determining by the remote station the maximum duration of the WLAN packets transmitted by the local station; and
adapting the transmission of WLAN packets by the remote station to ensure that the length of WLAN packets is not substantially longer than the maximum duration of the WLAN packets transmitted by the local station.

17. A method as recited in claim 12, wherein the WLAN packets are transmitted using IEEE 802.11 protocol.

18. A method comprising:
observing by one station a maximum fragment duration of wireless packets transmitted by another station; and
changing the fragment duration of transmission of the wireless packets by the observing station to a maximum fragment duration not substantially greater than the other station.

19. A method as recited in claim 18 wherein said wireless packets transmitted by the one station are fragmented.

20. A method as recited in claim 18 further comprising:
observing by the one station an increase in the maximum fragment duration of wireless packets transmitted by another station; and
in response to the observed increase, increasing the fragment duration of transmission of the wireless packets by the observing station by changing the wireless packets transmitted by the observing station to de-fragmented packets.
